(19) United States
(12) Patent Application Publication
(10) Pub. No.: US 2026/0121755 A1
(43) Pub. Date: Apr. 30, 2026

(54) HIERARCHICAL REDUNDANCY WITH PARALLEL OPTICAL LINKS

(71) Applicant: Volantis Semiconductor, Inc., Portland, OR (US)

(72) Inventor: Tapabrata Ghosh, San Francisco, CA (US)

(73) Assignee: Volantis Semiconductor, Inc., Portland, OR (US)

(21) Appl. No.: 19/211,446

(22) Filed: May 19, 2025

Related U.S. Application Data
(63) Continuation-in-part of application No. 19/210,116, filed on May 16, 2025.
Application No. 19/210,116 is a continuation-in-part of application No. 19/192,587, filed on Apr. 29, 2025.
Application No. 19/192,587 is a continuation-in-part of application No. 19/192,146, filed on Apr. 28, 2025.
Application No. 19/192,146 is a continuation-in-part of application No. 19/189,471, filed on Apr. 25, 2025.
Application No. 19/189,471 is a continuation-in-part of application No. 19/188,057, filed on Apr. 24, 2025.
Application No. 19/188,057 is a continuation-in-part of application No. 19/177,834, filed on Apr. 14, 2025.
Application No. 19/177,834 is a continuation-in-part of application No. 19/093,546, filed on Mar. 28, 2025.
Application No. 19/093,546 is a continuation-in-part of application No. 19/079,851, filed on Mar. 14, 2025.
Application No. 19/079,851 is a continuation-in-part of application No. 19/056,456, filed on Feb. 18, 2025.
Application No. 19/056,456 is a continuation-in-part of application No. 19/023,647, filed on Jan. 16, 2025.
Application No. 19/023,647 is a continuation-in-part of application No. 18/978,188, filed on Dec. 12, 2024.
Application No. 18/978,188 is a continuation-in-part of application No. 18/958,107, filed on Nov. 25, 2024.
Application No. 18/958,107 is a continuation-in-part of application No. 18/940,944, filed on Nov. 8, 2024.
(60) Provisional application No. 63/714,353, filed on Oct. 31, 2024.
(60) Provisional application No. 63/720,216, filed on Nov. 14, 2024.
(60) Provisional application No. 63/750,817, filed on Jan. 29, 2025.
(60) Provisional application No. 63/750,822, filed on Jan. 29, 2025.

(51) Int. Cl. H04B 10/50; H04B 10/032

(52) U.S. Cl. CPC H04B 10/503; H04B 10/032; H04B 10/506

(57) ABSTRACT

Disclosed techniques for improved data transmission are disclosed. A plurality of optical links is bundled. Each optical link in the plurality of optical links includes an optical modulator, an optical coupler, and an optical medium. The plurality of optical links includes at least one spare optical link. The bundling results in a bundle of optical links. At least two bundles of optical links are grouped. The grouping results in a hierarchical grouping of optical links. One or more optical links within the group are tested. The testing includes identifying a failing optical link within the optical links that were tested. A controller replaces the failing optical link with a spare optical link. The spare optical link is within any bundle within the group. Data is transmitted from a source to the spare optical link. The transmitting includes forwarding the data from the spare optical link to a destination.

### RELATED APPLICATIONS

This application is a continuation-in-part of U.S. patent application “Waveguides Based On Nanoimprint Lithography On A Photonic Wafer Scale Interposer” Ser. No. 19/210,116, filed May 16, 2025.

The U.S. patent application “Waveguides Based On Nanoimprint Lithography On A Photonic Wafer Scale Interposer” Ser. No. 19/210,116, filed May 16, 2025 is also a continuation-in-part of U.S. patent application “Photonic Wafer-Scale Interposer With Mirrors Based on Nanoimprint Lithography” Ser. No. 19/192,587, filed Apr. 29, 2025.

The U.S. patent application “Photonic Wafer-Scale Interposer With Mirrors Based on Nanoimprint Lithography” Ser. No. 19/192,587, filed Apr. 29, 2025, is also continuation-in-part of U.S. patent application “Photonic Wafer-Scale Interposer With Micro Transfer Printed VCSELS And Back Side Power Delivery” Ser. No. 19/192,146, filed Apr. 28, 2025.

The U.S. patent application “Photonic Wafer-Scale Interposer With Micro Transfer Printed VCSELS And Back Side Power Delivery” Ser. No. 19/192,146, filed Apr. 28, 2025 is also a continuation-in-part of U.S. patent application “Photonic Wafer Scale Interposer With Integrated Crystallographic Etched Mirrors And Pre-Angled Light” Ser. No. 19/189,471, filed on Apr. 25, 2025.

The U.S. patent application “Photonic Wafer Scale Interposer With Integrated Crystallographic Etched Mirrors And Pre-Angled Light” Ser. No. 19/189,471, filed on Apr. 25, 2025, is also a continuation-in-part of U.S. patent application “Photonic Wafer Scale Interposer With Angled Beam Grating Couplers”Ser. No. 19/188,057, filed Apr. 24, 2025.

The U.S. patent application “Photonic Wafer Scale Interposer With Angled Beam Grating Couplers” Ser. No. 19/188,057, filed Apr. 24, 2025, is also a continuation-in-part of U.S. patent application “Back Side Power Delivery For Wafer-Scale Integration With An Isometric Grid Array With Compression Pins”Ser. No. 19/177,834, filed on Apr. 14, 2025.

The U.S. patent application “Back Side Power Delivery For Wafer-Scale Integration With An Isometric Grid Array With Compression Pins” Ser. No. 19/177,834, filed on Apr. 14, 2025, is also a continuation-in-part of U.S. patent application “Back Side Power Delivery For Wafer-Scale Integration With Laser Assisted Bonding” Ser. No. 19/093,546, filed on Mar. 28, 2025.

The U.S. patent application “Back Side Power Delivery For Wafer-Scale Integration With Laser Assisted Bonding” Ser. No. 19/093,546, filed Mar. 28, 2025, is also a continuation-in-part of U.S. patent application “Photonic Wafer-Scale Interposer With Tapered Waveguides”Ser. No. 19/079,851, filed Mar. 14, 2025.

The U.S. patent application “Photonic Wafer-Scale Interposer With Tapered Waveguides” Ser. No. 19/079,851, filed Mar. 14, 2025, is also a continuation-in-part of U.S. patent application “Back Side Power Delivery For Wafer-Scale Integration With An Isometric Grid Compression Plate” Ser. No. 19/056,456, filed Feb. 18, 2025, which claims the benefit of U.S. provisional patent applications “Chiplet-Based Optical Wafer-Scale Network Switch” Ser. No. 63/750,817, filed Jan. 29, 2025, and “Wafer-Scale Integration Power Delivery With An Isotropic Conductive Adhesive”Ser. No. 63/750,822, filed Jan. 29, 2025.

The U.S. patent application “Back Side Power Delivery For Wafer-Scale Integration With An Isometric Grid Compression Plate” Ser. No. 19/056,456, filed Feb. 18, 2025, is also a continuation-in-part of U.S. patent application “Back Side Power Delivery For Wafer-Scale Integration With Solderless Modular Power Substrates” Ser. No. 19/023,647, filed Jan. 16, 2025, which claims the benefit of U.S. provisional patent applications “Cooling For Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Back Side Power Delivery For Wafer-Scale Integration With Solderless Modular Power Substrates” Ser. No. 19/023,647, filed Jan. 16, 2025 is also a continuation-in-part of U.S. patent application “Wafer-Scale Integration With A Stiffening Isometric Grid Array” Ser. No. 18/978,188, filed Dec. 12, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Wafer-Scale Integration With A Stiffening Isometric Grid Array” Ser. No. 18/978,188, filed Dec. 12, 2024 is also a continuation-in-part of U.S. patent application “Cold Plate Cooling For Wafer-Scale Integration With Back Side Modular Power Delivery” Ser. No. 18/958,107, filed Nov. 25, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film”Ser. No. 63/720,216, filed Nov. 14, 2024.

The U.S. patent application “Cold Plate Cooling For Wafer-Scale Integration With Back Side Modular Power Delivery” Ser. No. 18/958,107, filed Nov. 25, 2024, is also a continuation-in-part of U.S. patent application “Back Side Wafer-Scale Integration With Modular Power Delivery” Ser. No. 18/940,944, filed Nov. 8, 2024, which claims the benefit of U.S. provisional patent application “Cooling for Wafer-Scale Integration With Back Side Power Coupling” Ser. No. 63/714,353, filed Oct. 31, 2024.

Each of the foregoing applications is hereby incorporated by reference in its entirety.

### FIELD OF ART

This application relates generally to transmitting data and more particularly to hierarchical redundancy with parallel optical links.

### BACKGROUND

Humans have developed a variety of techniques by which they can communicate. The techniques have evolved over millennia and include spoken languages, pictorial languages, and written languages, among others. Written languages were particularly useful because they enabled information including beliefs, concepts, ideas, and significant events to be stored over time. The written information could be transported over distances, copied and shared with others, and translated for others to understand, among other benefits. However, the classical media for written language including stone, clay, wood, animal skin, and plant based materials could be lost or broken, could decay, or otherwise become unusable. Further, conveying information required reliable couriers and could take significant time due to long distances, dangerous routes, and weather delays. Thus, the development of communications techniques that could share information over distances was of paramount importance. Communications techniques such as telegraphy and telephony enabled coded or spoken information to be shared quickly over many distances. The medium by which telegraphy and telephony communications were sent and received was based on copper wire.

The copper wire used for telegraphy and telephony could be dedicated to serve particular users or could be shared by time multiplexing the communications. The multiplexing enabled the copper wires to be shared by allowing a group of two or more users to use the copper wires at one time and other groups of two or more users to use the copper at other times. This model worked well for small numbers of users, but as the number of users grew, a medium that was able to handle multiple groups of users simultaneously was sought. One medium that is well suited to handling many users simultaneously is based on low loss optical fiber. The optical fiber supports many simultaneous communications by allocating the optical fiber to various groups based on time, wavelength of light, and other techniques. Thus, optical fiber was and remains an advantageous communication medium.

The widespread deployment of optical fibers began in earnest in the 1980s, when fiber was deployed to replace the old and inadequate copper cables. Popular routes for fibers included railroad lines, where the communications companies could contract rights of way for the cables and could get heavy equipment immediately adjacent to where the fiber was deployed, thus simplifying installation. In addition to the land-based deployment of fiber, submarine cables were deployed. These latter cables replaced older copper cables, greatly enhancing the amount of information that could be carried via cables under the ocean. Further, the submarine cables greatly enhanced global connectivity, by providing high speed connections between continents. With the newly deployed fibers, advanced communications techniques were developed that enabled sharing the fiber based of wavelengths (colors) of light. And more recently, Fiber to the Home (FTTH) has connected households to high speed networks even in remote areas. As communications techniques continue to develop, ever faster connections will benefit even more users.

### SUMMARY

The doubling of the number of active devices in a microchip every two years has more or less held true since Gordon Moore first made his prediction in 1965. The doubling has been supported by technological advancements, improved processor architectures, and even advanced mathematical techniques. The increased active device (e.g., transistor) count has greatly bolstered processing power and storage capacity, while reducing processing cost from a per-transistor basis. As a result, users demand ever faster performance from their electronic systems. Beyond hardware performance demands, the applications further drive the necessity for new circuit designs and architectures for the devices and the applications. Popular and innovative device features also create new technological and architectural improvement demands. These popular features now routinely include biometric authentication, high resolution cameras, and three-dimensional or “spatial” audio. Whether the computers span vast, multisite server farms, or are handheld devices, users are not satisfied with the current state-of-the-art of their hardware and the software they use.

The latest processors and applications are significantly faster and more capable than previous generations of both the hardware and the software. The speed improvements and application capability enhancements are due in part to increased numbers of smaller, faster active devices, architectures better suited to handling AI and ML processing, and so on. However, data access and transfer have remained limiting factors in processing performance. The data issues limit processing due to the massive amounts of data that are accessed and processed in order to train the AI models, the ML models, and so on. Further, once the models are trained, the production models process even great amounts of data, and the results of processing the data are often used to update the production models to increase processing accuracy and convergence rapidity. Techniques for improving data access and transmission have been implemented, such as enabling parallel access to data, configuring special data buses, and so on. However, the amount of time required to access the data and to transmit the data between and among processors remains high, particularly when the processors are located on different cards such as multiprocessor cards, within different data racks, or even in different data centers. Various techniques involving wider buses, multiple buses, and so on have been used, but congestion on the buses slows the data transfer. Also, buses, channels, etc. can degrade or fail, further constraining data access and transfer.

Disclosed techniques enable hierarchical redundancy with parallel optical links. A plurality of optical links is bundled. Each optical link in the plurality of optical links includes an optical modulator, an optical coupler, and an optical medium. The plurality of optical links includes at least one spare optical link, and the bundling results in a bundle of optical links. At least two bundles of optical links are grouped. The grouping results in a group of optical links. One or more optical links within the group are tested. The testing includes identifying a failing optical link within the one or more of optical links that were tested. A controller replaces the failing optical link with a spare optical link. The spare optical link is within any bundle within the group. Data is transmitted from a source to the spare optical link. The transmitting includes forwarding the data from the spare optical link to a destination. In embodiments, the source comprises a first chiplet and the destination comprises a second chiplet. The first chiplet and the second chiplet are within a plurality of chiplets bonded to a front side of a phonic wafer-scale interposer (PWSI).

A method for transmitting data is disclosed comprising: bundling a plurality of optical links, wherein each optical link in the plurality of optical links includes an optical modulator, an optical coupler, and an optical medium, wherein the plurality of optical links includes at least one spare optical link, and wherein the bundling results in a bundle of optical links; grouping at least two bundles of optical links, wherein the grouping results in a group of optical links; testing one or more optical links, within the group, wherein the testing includes identifying a failing optical link within the one or more of optical links that were tested; replacing the failing optical link, by a controller, with a spare optical link, wherein the spare optical link is within any bundle within the group; and transmitting data from a source to the spare optical link, wherein the transmitting includes forwarding the data from the spare optical link to a destination.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for hierarchical redundancy with parallel optical links.

FIG. 2 is a flow diagram for providing power.

FIG. 3 is a diagram of a bundle.

FIG. 4 is a diagram of groups of bundles.

FIG. 5 is diagram of a waveguide.

FIG. 6 is a cross section of a VCSEL.

FIG. 7 is a cross-section of a photonic wafer-scale interposer (PWSI).

FIG. 8 is an apparatus for hierarchical redundancy with parallel optical links.

FIG. 9 is a system diagram for hierarchical redundancy with parallel optical links.

### DETAILED DESCRIPTION

Techniques for transmitting data using hierarchical redundancy with parallel optical links are disclosed. Advanced and evolving, computationally intensive applications perform significant data accesses and transfers. Considering artificial intelligence (AI) models and machine learning (ML) models as examples, the amount of storage that is accessed during model training and operation can approach 32GB, 64GB, or more. Since the volume of data is so high, data transmission times from sources such as storage elements to destinations such as processors significantly affect processing times. Various processing and data access architectural approaches have included faster processors, faster buses, faster memory, and so on. However, faster processors can be starved for data if the data does not arrive in time. Further, faster buses alone do not solve the access issues when the data sources and destinations are located in different processors, different data racks, or even different data centers. In addition, components that are used for transmitting data can degrade or fail over time. In particular, vertical-cavity surface emitting lasers (VCSELs) can be unreliable in the field. This, in addition to provided faster data transmission techniques, the elements associated with the data transmission require testing, and if failing or failed, replacement. Some implementations overcome reliability issues by replacing components, optical media, etc. through the use of a large cross bar. The cross bar can re-rout signals to working optical links, but can introduce complexity and timing issues, especially when a large number of optical links are required.

To address the technical challenges of enabling redundant highspeed data communications between and among processors, techniques for hierarchical redundancy with parallel optical links are disclosed. A plurality of optical links is bundled. Each optical link in the plurality of optical links includes an optical modulator, an optical coupler, and an optical medium. The plurality of optical links includes at least one spare optical link. The bundling results in a bundle of optical links. At least two bundles of optical links are grouped. The grouping results in a group of optical links. One or more optical links within the group are tested. The testing includes identifying a failing optical link within the one or more of optical links that were tested. A controller replaces the failing link with a spare optical link. The spare optical link is within any bundle within the group. Data is transmitted from a source to the spare optical link. The transmitting includes forwarding the data from the spare optical link to a destination. The source comprises a first chiplet, and the destination comprises a second chiplet. The first chiplet and the second chiplet are within a plurality of chiplets bonded to a front side of a phonic wafer-scale interposer (PWSI).

A plurality of modular power substrates (MPSs) can be coupled to a back side of the PWSI. The plurality of MPSs can also be coupled to a unified control board (UCB). The coupling can be based on a plurality of sockets. The UCB can include a plurality of DC-to-DC power converters. DC power can be delivered, by the UCB, to the plurality of chiplets. The delivering can be based on the plurality of DC-to-DC power converters, the plurality of MPSs, and the plurality of TSVs. The delivering can include a first voltage conversion. The DC power can be transferred from the UCB, by the plurality of MPSs, to the plurality of chiplets. The transferring can include a second voltage conversion.

The coupling can include compressing the PWSI. The compressing can be on coupling an isometric grid array (IGA) to a cold plate. The cold plate can remove a portion of excess heat generated by the plurality of chiplets. The compressing can be based on one or more spring loaded fasteners, one or more clamps, and so on. The fasteners can be configured to provide a desired amount of compression. The compressing can maintain a coplanarity of the PWSI. The MPSs can provide power to the plurality of chiplets and other electronic elements. Data can be transmitted between chiplets to which power is provided using an optical link. The optical link can include an optical modulator, an optical coupler, and an optical medium.

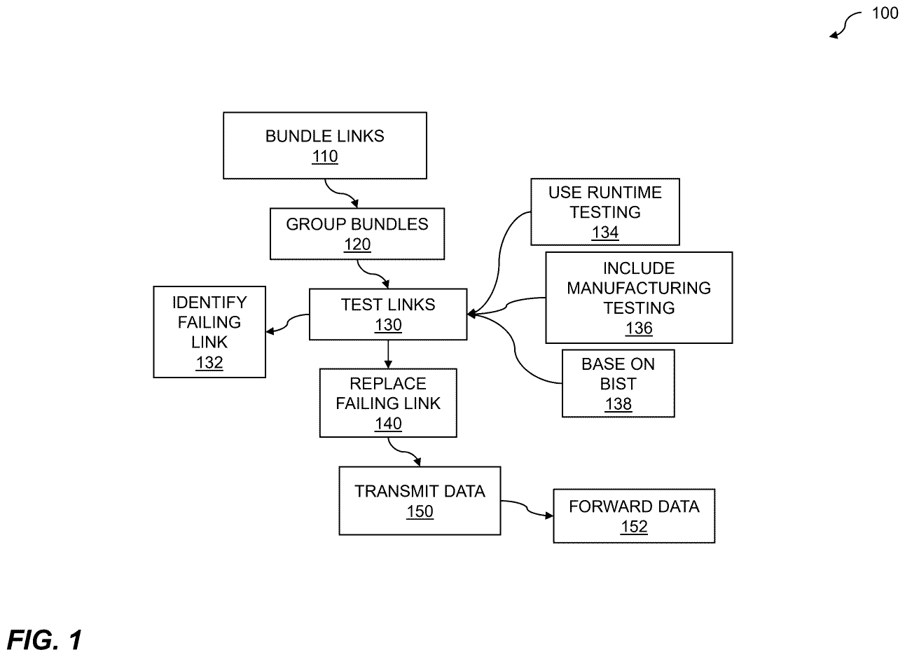

FIG. 1 is a flow diagram for hierarchical redundancy with parallel optical links. The flow 100 comprises bundling 110 a plurality of optical links, wherein each optical link in the plurality of optical links includes an optical modulator, an optical coupler, and an optical medium, wherein the plurality of optical links includes at least one spare optical link, and wherein the bundling results in a bundle of optical links. The plurality of optical links enables high-speed transmitting of data. The transmitting can occur between a source and a destination. The source and the destination can include functional chips, chiplets, processors, memories, AI accelerators, ML accelerators, switching chiplets, and so on. In embodiments, the source comprises a first chiplet, wherein the destination comprises a second chiplet, wherein the first chiplet and the second chiplet are within a plurality of chiplets bonded to a front side of a phonic wafer-scale interposer (PWSI). The PWSI can include a wafer such as a silicon wafer or a glass wafer, a circuit board, etc. The optical modulator converts electronic data to optical data by emitting light that is based on the electronic data. The optical modulator can be based on a variety of techniques. In embodiments, each optical modulator within the plurality of optical links comprises a surface-emitting light source. The surface-emitting light source can emit a wavelength of light, a band of wavelengths of light, polarization modulated light, mode-modulated light, wavelength modulated light, and so on. In embodiments, each optical modulator within the plurality of optical links comprises a vertical-cavity surface-emitting laser (VCSEL), wherein each VCSEL is bonded to the front side of the PWSI, and wherein each VCSEL is within the plurality of chiplets. The surface-emitting light source can include a laser diode (LD), a light emitting diode (LED), and the like.

The optical couplers can be based on a variety of optical coupler techniques. In embodiments, each optical coupler within the plurality optical links comprises a mirror. The mirror can be fabricated using a nanoimprint lithography (NIL) process. Structures fabricated by the NIL process can be coated with a reflective material. In other embodiments, each optical coupler within the plurality optical links comprises a bent waveguide. The bent waveguide can include a high-containment region of a waveguide which minimizes loss of light from the waveguide. In further embodiments, each optical coupler within the plurality optical links comprises a grating coupler. The grating coupler, which can include a periodic coupler, can be tuned to maximize transfer of the wavelength of light or a band of wavelengths of light. The optical medium enables transmission of light that is coupled from the surface-emitting light source, by the optical coupler, into the optical medium. In embodiments, each optical medium within the plurality of optical links comprises a waveguide within the PWSI. In a usage example, a waveguide can enable high-speed communication between a source chiplet and a destination chiplet on the PWSI. The optical links can include electrooptical devices, photonic devices, and so on. In embodiments, each optical link within the plurality of optical links includes a photodiode. The photodiode can receive an optical signal sent by a VCSEL through the optical medium and convert the optical signal to an electrical signal which can be read by the second chiplet. In some embodiments, the source and the destination comprise silicon photonics chips. A silicon photonics chip can be a photonic integrated circuit (PIC). A PIC can integrate optical components with traditional semiconductor logic. The PIC can be used to send data as light signal between chips. In further embodiments, the optical medium within the plurality of optical links comprises a multicore fiber. The multicore fiber can carry optical signals from the PICs between chips.

The flow 100 comprises grouping 120 at least two bundles of optical links, wherein the grouping results in a group of optical links. The grouping can enable hierarchical redundancy within a PWSI, or in other photonic implementations. This hierarchical redundancy can eliminate the need for large crossbar switches which can introduce complexity and timing issues into the process of replacing poor or non-performing links. Each bundle within a group of optical links can include a substantially similar number of optical links and spare optical links or substantially dissimilar numbers of optical links and spare optical links. The group of optical links can include a spare bundle of optical links. The flow 100 includes testing 130 one or more optical links, within the group, wherein the testing includes identifying 132 a failing optical link within the one or more of optical links that were tested. One or more elements of an optical link can underperform, degrade, or fail. The elements that can be tested include the optical modulator, the optical coupler, the optical medium, and so on. A failure can occur due to one or more of fabrication errors, degradation of an element over time, etc. Testing the optical links identifies a failed or failing optical link. The failed or failing optical link can be “removed” from service by indicating that the link should not be used for transmitting data. The failed or failing link can be replaced (discussed below). Various testing techniques can be used to identify a problematic link. In embodiments, the testing comprises runtime testing 134. The runtime testing can be performed on optical links between data transmissions, such as testing a link when the link is idle. In other embodiments, the testing comprises manufacturing testing 136. Manufacturing testing can be performed at various stages of the manufacturing processes associated with the optical elements comprising the optical links. The manufacturing testing can confirm contact and interconnect integrity, device operation within design specifications, and the like. With manufacturing testing, underperforming or failed components can be identified and discarded long before the components are introduced to a system, the PWSI, etc. In further embodiments, the testing is based on built-in self-test (BIST) 138. The BIST can be performed upon system startup, when a device is idle, etc. The runtime testing and the BIST can be performed by a controller (explained below).

The flow 100 comprises replacing 140 the failing optical link, by a controller, with a spare optical link, wherein the spare optical link is within any bundle within the group. The replacing a failing link with a spare link can be accomplished by “swapping out”, deselecting, or otherwise identifying the failing like as unsuitable for use. The identifying the failed optical link is based on the results of the testing the optical links. In embodiments, the replacing comprises a redundancy implementation. The replacing can include replacing the failed optical link with a spare link within the same bundle as the failed optical link. The replacing can include replacing the failed optical link with a spare bundle within the same group, within a different group, and so on. In embodiments, the spare optical link is within the second group. Recall that the second group includes at least one spare optical link. In embodiments, the second group comprises a spare bundle of optical links. Thus, the second group can implement redundancy. In embodiments, the grouping, the testing, and the replacing include a second group. The choice of using a spare link in the second group can be based on testing the optical links within the second group. The controller that performs the replacing can also perform the testing. The controller can include a processor, a controller such as a microcontroller, and so on. In embodiments, the controller comprises a shift register. The shift register can be used to shift one or more selection bits, a code, and so on. The shift register can disable failing links, select spare links, etc.

The flow 100 comprises transmitting 150 data from a source to the spare optical link, wherein the transmitting includes forwarding 152 the data from the spare optical link to a destination. The transmitting data from the source to the destination can be controlled by the controller. In embodiments, the source and the destination comprise silicon photonics chips. The photonics chips can include photonic switching chips. The source sends data, such as electronic data, to an optical modulator selected by the controller. The electronic data can include serial electronic data. The optical modulator converts the electronic data to optical data. The optical data, which is based on light, can include serial optical data. The optical coupler associated with the optical link couples the light (e.g., serial optical data) from the optical modulator to the optical medium. The optical medium can include a waveguide within the PWSI. In embodiments, the optical medium within the plurality of optical links comprises a multicore fiber. The optical medium conveys the optical data to an optical receiver. In embodiments, each optical link within the plurality of optical links includes a photodiode. The photodiode converts the optical data to electronic data. The electronic data can be routed to the receiver.

Various steps in the flow 100 may be changed in order, repeated, omitted, or the like without departing from the disclosed concepts. Various embodiments of the flow 100, or portions thereof, can be included in an apparatus for transferring data or system that is configured to transfer data.

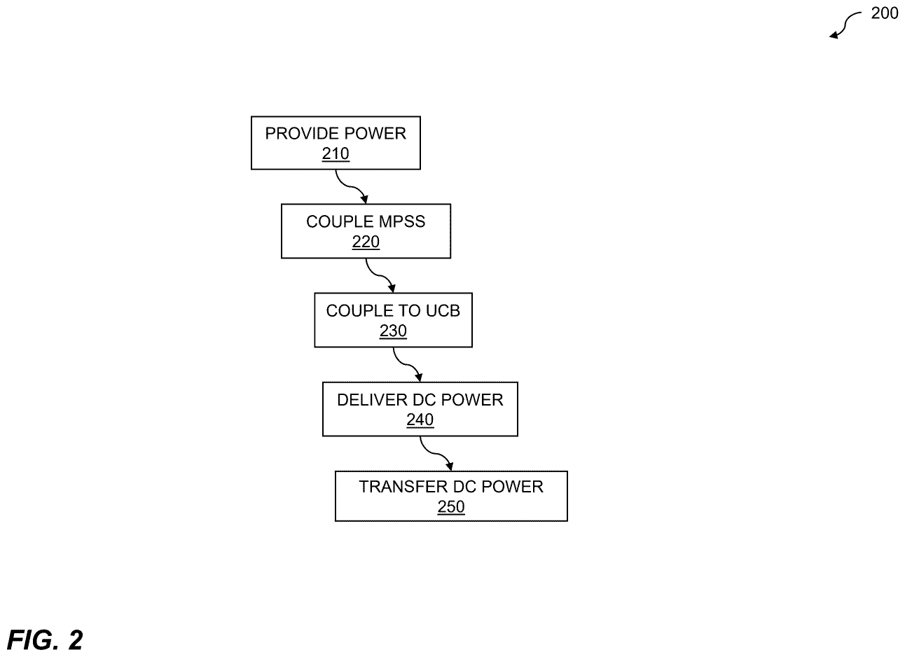

FIG. 2 is a flow diagram for providing power. The providing power can enable operation of active electronic elements. Integrated circuits or chips such as chiplets, optical modulators such as surface-emitting light sources, functional chips, and so on can be bonded, coupled, etc. to a circuit board, a wafer, an interposer, and so on. The interposer can include a photonic wafer-scale interposer (PWSI). The bonding can be accomplished using solder bumps such as micro-bumps, C4s, and the like. The use of the PWSI supports wafer-scale integration (WSI), which is particularly useful to enabling data transmission requirements that support the processing requirements of computationally intensive applications such as artificial intelligence (AI) acceleration, machine learning (ML) applications, natural language (NL) applications, etc. Data is transmitted between chiplets by using optical links, where each optical link includes an optical modulator, an optical coupler, and an optical medium. A plurality of optical links is bundled, where the plurality of optical links includes at least on spare optical links. At least two bundles are grouped, resulting in a group of optical links, resulting in a hierarchical redundancy of optical links.

The optical links are tested, and an optical link that is determined to be failing is replaced with a spare optical link. Thus, data is transmitted between a source chiplet and a destination chip using the spare link. The chiplets, optical modulators such as surface-emitting light sources, optical receivers, and so on that enable transmitting data to support the computationally intensive applications require significant amounts of power during operation. The power, which includes DC power, must be provided to the chiplets, the light sources, and functional chips. The power can be provided using modular power delivery techniques. At least a portion of the generated heat can be transferred to a cold plate, where the heat can be transferred to a coolant that can be circulated through the cold plate, a heat exchanger, etc. Thus, providing DC power via back side power delivery enables a photonic wafer-scale interposer with micro transfer printed VCSELs. The PWSI can include a 300 mm wafer, a 200 mm wafer, or a wafer of another size.

The flow 200 includes providing power 210 to a plurality of chiplets, wherein the providing is based on a back side of the PWSI, and wherein the PWSI includes a plurality of through-silicon vias (TSVs). The providing power can include providing DC power. The chiplets, surface-emitting light sources, functional chips, controllers, etc. require power such as DC power to operate. Described previously, the power can be provided by coupling one or more power modules (described below) to a backside of the PWSI. In order for the power to reach the chiplets, light sources, and other elements, the power can be provided from the back side of the PWSI to the front side of the PWSI using the TSVs.

The flow 200 includes coupling 220, to the back side of the PWSI, a plurality of modular power substrates (MPSs). The coupling can be accomplished using a variety of techniques. The coupling can be based on a plurality of elastomer sheets. The elastomer sheets can include conducting filaments. The conducting filaments can provide a conduction path from a front side of an elastomer sheet to a back side of the elastomer sheet. The conducting fibers can include carbon fibers, graphene fibers, metal fibers such as copper fibers or silver fibers, and so on. The coupling can be based on a laser-assisted bonding (LAB) technique. Using LAB, solder balls, such as microbumps and C4s, can be melted using a laser. The melting the solder balls using a laser tightly concentrates heating to the solder balls while leaving materials adjacent to the solder balls unheated. Thus, previous fabrication steps such as diffusion, soldering, and so on remain unheated and thereby unchanged. In a usage example, each MPS within the plurality of MPS can be inserted into an isometric grid array (IGA). The IGA can maintain a coplanarity of the PWSI, where coplanarity of the PWSI enables reliable electrical and mechanical couplings between the plurality of MPSs and the PWSI. The PWSI can be delicate and prone to cracking and breaking due to its thinness. The IGA further supports the PWSI, thereby reducing risk to the PWSI while handing the PWSI and while the PWSI is in operation.

The flow 200 includes coupling 230 the plurality of MPSs to a unified control board (UCB), wherein the coupling is based on a plurality of sockets, and wherein the UCB includes a plurality of DC-to-DC power converters. The coupling can be accomplished using plug-and-socket connectors, terminals, cables, jumpers, and so on. Noted previously and throughout, power such as DC power must be delivered to the chiplets bonded to the front side of the PWSI in order for the chiplets to operate. The DC power must also be delivered to other elements coupled to the PWSI such as the one or more digital controller chips, surface-emitting light sources, functional chips, and so on. Embodiments can include providing power such as DC power to the plurality of chiplets. In a usage example, the coupling the plurality of MPSs to the UCB can be accomplished using DC power connectors associated with the plurality of MPSs and the plurality of sockets associated with the UCB. The coupling can further be accomplished using a plurality of rigid-flex strips. The plurality of rigid-flex strips can also carry control signals from the digital controller chips to control power delivery. The coupling can be based on a high voltage socket. The UCB can include other chips, chiplets, and so on. The UCB can include one or more digital controller chips to control the DC-to-DC power converters. The digital controller chips can comprise one or more of a processor, a multiprocessor, a microcontroller, and so on. The one or more digital controller chips can control the DC-to-DC power converters.

The flow 200 includes delivering DC power 240, by the UCB, to the plurality of chiplets, wherein the delivering is based on the plurality of DC-to-DC power converters, the plurality of MPSs, and the plurality of TSVs, and wherein the delivering includes a first voltage conversion. The delivering DC power can include delivering DC power to a subset of MPSs. The delivering DC power can be accomplished by coupling one or more DC-to-DC converters to one or more MPSs. Interconnection between the DC-to-DC converters matched with one or more respective MPSs can be accomplished using interconnect associated with the UCB. The DC power that is delivered can include a range for the DC voltage. The range of DC voltage can include a percentage of a target voltage, an allowable operating range of DC voltage, and the like. In a usage example, the voltage range can include 48 volts to 54 volts, inclusive. The delivering can include a first voltage conversion.

The flow 200 further includes transferring 250 the DC power that was delivered, by the plurality of MPSs, to the plurality of chiplets, wherein the transferring includes a second voltage conversion. The plurality of chiplets can obtain the directed power using interconnect, contacts, and so on. The chiplets and other electronic elements can also use interconnect and contacts to receive and send data, instructions, control signals, etc. The second voltage conversion can be accomplished using one or more converters such as DC-to-DC converters associated with the MPSs. The second voltage conversion can produce a voltage that can be used directly to operate one or more chiplets. The second voltage conversion can attain a voltage less than the voltage resulting from the first voltage conversion. The second voltage conversion can result in a voltage less than a threshold. The threshold can include a target voltage, an operating voltage, and so on. In a usage example, the threshold is 1 volt. The transferring is based on the plurality of TSVs. The transferring can include transferring DC power, receiving and sending data, sending and receiving functional chip instructions and control signals, etc.

Various steps in the flow 200 may be changed in order, repeated, omitted, or the like without departing from the disclosed concepts. Various embodiments of the flow 200, or portions thereof, can be included in an apparatus for transferring data or system that is configured to transfer data.

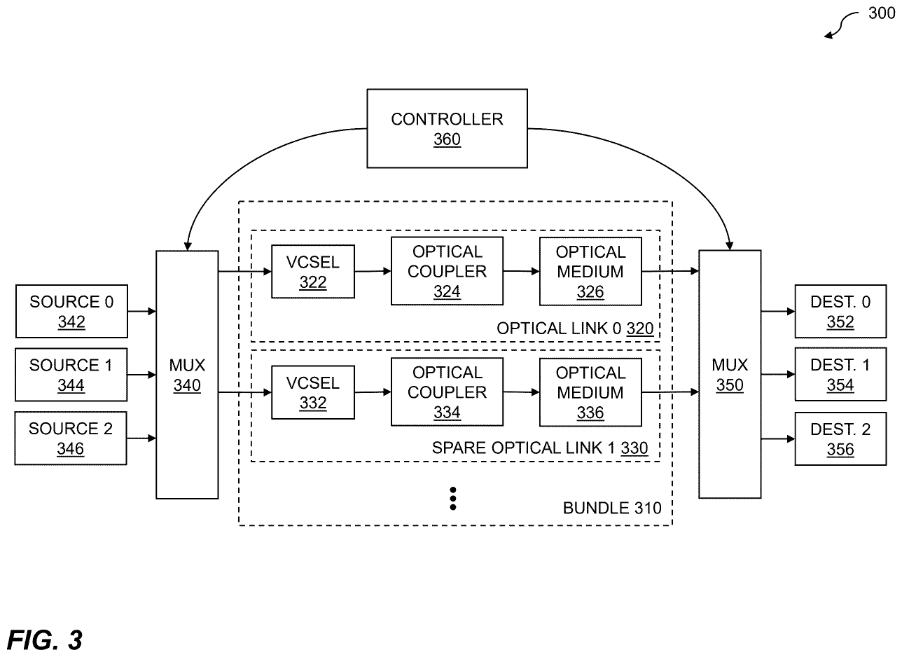

FIG. 3 is a diagram of a bundle. An optical link includes an optical modulator, an optical coupler, and an optical medium. The optical link is used to transmit data between a source, such as a source chiplet, and a destination, such as a destination chiplet. The source chiplet and the destination chiplet can include chiplets within a plurality of chiplets that are bonded to a wafer, a circuit board, an interposer, and so on. The interposer can include a photonic wafer-scale interposer (PWSI). A plurality of optical links can be bundled, and the bundle can be controlled. Bundles of optical links can be grouped to form groups of bundles of optical links. A bundle of optical links includes at least one spare optical link. Since elements associated with each optical link, such as the optical modulator, the optical coupler, or the optical medium can underperform or fail, each optical link can be tested. When test results associated with an optical link indicate that the optical link is underperforming or failing, the optical link can be replaced by a spare optical link. Thus, bundling a plurality of optical links that include at least one spare optical link enables hierarchical redundancy with parallel optical links.

The diagram 300 shows a bundle of optical links. A bundle of optical links 310 includes a plurality of optical links. The bundle includes optical link 0 320 and spare optical link 1 330. While two optical links are shown, the plurality of optical links can include other numbers of links, both operational links and spare links. Recall that a bundle includes at least one spare optical link. In the FIG. 300, spare optical link 1 can comprise a spare optical link. In embodiments, each optical link in the plurality of optical links includes an optical modulator, an optical coupler, and an optical medium. Optical link 0 includes optical modulator VCSEL 322, optical coupler 324, and optical medium 326. The optical modulator can include a light source such as a surface emitting light source. In embodiments, each optical modulator within the plurality of optical links comprises a vertical cavity surface emitting laser (VCSEL), wherein each VCSEL is bonded to the front side of the PWSI, and wherein each VCSEL is within the plurality of chiplets. The optical modulator can also comprise a laser diode (LD), a light emitting diode (LED), and so on. A mix of optical modulators can be included within the plurality of optical links.

The optical coupler 324 can couple light from the VCSEL to the optical medium. Various techniques can be used to couple light from the VCSEL. In some embodiments, each optical coupler within the plurality optical links comprises a mirror. In other embodiments, each optical coupler within the plurality optical links comprises a bent waveguide. In some embodiments, each optical coupler within the plurality optical links comprises a grating coupler. A mix of the above, or other, optical couplers can be used within the plurality of optical links. In embodiments, each optical medium within the plurality of optical links comprises a waveguide within the PWSI. In some embodiments, the optical medium within the plurality of optical links comprises a multicore fiber. Again, a mix of the above optical links, or additional types of optical links, can be implemented. Spare optical link 1 also includes an optical modulator VCSEL 332, an optical coupler 334, and an optical medium 336 as described above. Each optical link can include an optical receiver (not shown in diagram 300). The optical receiver can convert optical data to electrical data. In embodiments, each optical link within the plurality of optical links includes a photodiode.

When an optical link fails, a spare optical link can be selected from a hierarchical group of optical link bundles. Each bundle can include at least one spare optical link. The hierarchical format can reduce the need for large crossbar switch(es). Embodiments include transmitting data from a source to the spare optical link, wherein the transmitting includes forwarding the data from the spare optical link to a destination. The source can be selected by a multiplexer (MUX) such as mux 340. Recall that source can include a switching chiplet, and AI chiplet, and so on. Three sources that are selectable by the mux, source 0 342, source 1 344, and source 2 346. If optical link 0 fails, the mux can route the signals from the sources to an optical link such as spare optical link 1. The mux can select any spare link from any bundle or any group. Data can be transmitted form the selected source to a selected destination. A mux such as mux 350 at the far end of the bundle of optical links can select the optical link that was used to transmit the data from the source and route the data to a destination. The mux 350 can route the transmitted data to destination 0 352, destination 1 354, destination 2 356, and so on. A controller 360 is used to control mux 340 and mux 350. The controller can select the source, route the source to an optical link within a bundle, select the output from the selected optical link, and route the output from the selected optical link to the destination. The controller can further be used to test the optical links within one or more bundles, switch out a failing link, replace the failing link with a spare link, and so on. In embodiments, the controller comprises a shift register. The shift register can shift a selection or control bit, a selection or control code, etc. The selection bit or code can be used to select the source, the optical link, and the destination.

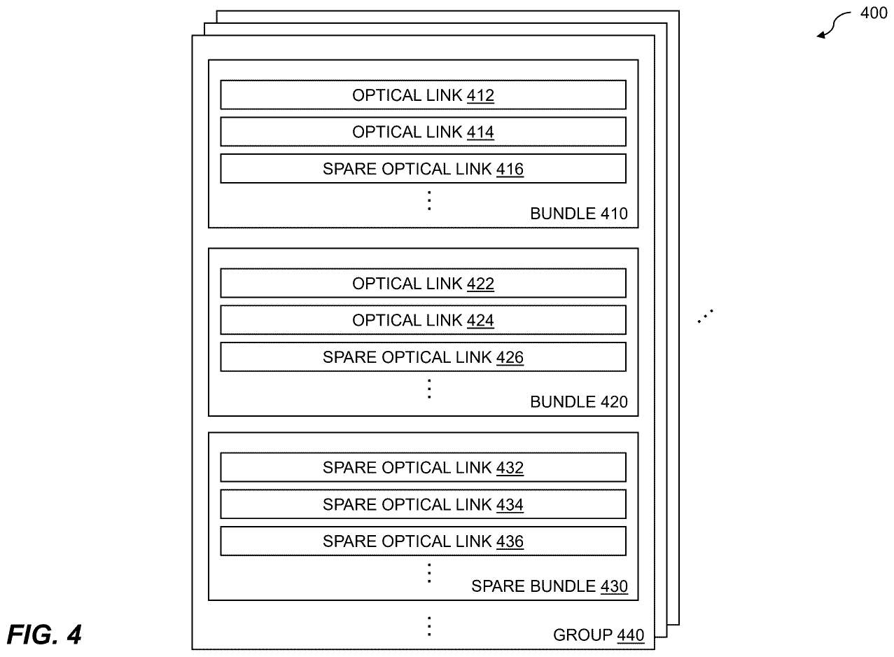

FIG. 4 is a diagram of groups of bundles. Discussed previously and throughout, a plurality of optical links is bundled. A bundle includes at least one spare optical link. Each optical link includes an optical modulator such as a vertical cavity surface emitting laser (VCSEL); an optical coupler such as a grating coupler; and an optical medium such as a waveguide. Bundles of optical bundles can be grouped into groups. Since an optical link may have a faulty or underperforming component due to a manufacturing defect, damage, degradation, and so on, one or more optical links within a group are tested in order to identify a failing optical link. When a failing optical link is identified, the failing link is replaced by a spare optical link. The spare optical link can include a link within any group of optical links. Data can be transmitted from a source to the spare optical link. The transmitting can include conveying data between a first chiplet and a second chiplets, where the first chiplet and the second chiplet are within a plurality of chiplets bonded to a front side of a phonic wafer-scale interposer (PWSI). The groups of bundles of optical links enable hierarchical redundancy with parallel optical links.

The diagram 400 shows bundles of optical links that are grouped into groups. Recall that a bundle of optical links includes at least one spare optical link. The bundles of optical links include bundle 410 and bundle 420. Bundle 410 includes two optical links, optical link 412 and optical link 414, and spare optical link 416. Similarly, bundle 420 includes two optical links, optical link 422 and optical link 424, and spare optical link 426. A bundle can include a bundle of spare optical links. In the FIG. 400, a spare bundle 430 includes three spare optical links, spare optical link 432, spare optical link 434, and spare optical link 436. The bundle 410, the bundle 420, and the spare bundle 430 are grouped into group 440. Recall that an optical link that is identified as failing is replaced with a spare optical link. The optical link can be within any bundle within any group. In a usage example, optical link 414 is tested and determined to be failing. Optical link 414 is replaced with a spare optical link. In embodiments, the spare optical link is within the second group. Continuing the usage example, spare optical link 426 can be used to replace a failing link in bundle 410. In other embodiments, the second group comprises a spare bundle of optical links. In the FIG. 400, spare bundle 430 comprises a group of spare optical links.

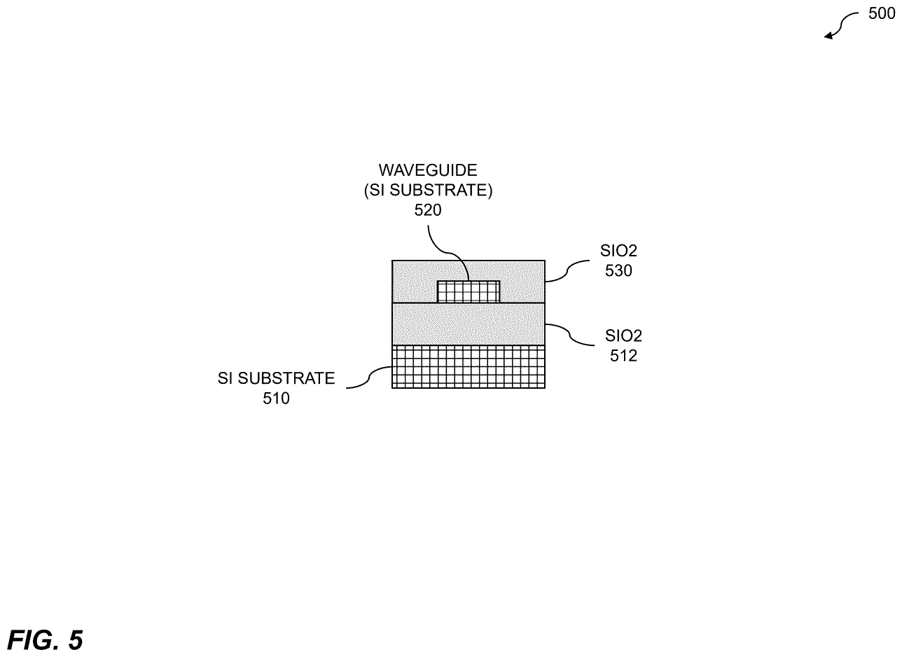

FIG. 5 is diagram of a waveguide. The waveguide is shown in cross-section. The waveguide can comprise an optical medium. The waveguide can include a waveguide within a plurality of waveguides within an interposer. In a usage example, the waveguide can be based on a nanoimprint lithography process on a photonic wafer-scale interposer. The waveguide can be fabricated in a technology such as a Silicon-on-Insulator (SOI) technology. A waveguide can be used to transmit a signal such as an optical signal between two elements such as chiplets. The transmitted signal can include transmitted data. The elements can include switching chiplets. The switching chiplets can be associated with a switch such an optical wafer-scale network switch. The waveguide can be fabricated within a monolithic wafer which includes one or more functional chips. The waveguide can be fabricated within a photonic wafer-scale interposer (PWSI), where the PWSI can be based on a wafer such as a silicon wafer, a glass wafer, and so on. The wafer can be used as a substrate for the PWSI. A plurality of waveguides can be fabricated within the PWSI in order to enable high speed, high bandwidth data transmission between chiplets. The transmitting between chiplets can include chiplets separated by a long distance on the PWSI. The waveguides can be tapered. The plurality of waveguides enable hierarchical redundancy with parallel optical links.

The figure includes a cross-section of an example waveguide. The example waveguide can be fabricated in a Silicon-on-Insulator (SOI) technology is shown 500 or in another fabrication technology. A silicon substrate 510 is used. The silicon substrate can include a silicon wafer, where the silicon wafer can include a 200 mm silicon wafer, a 300 mm silicon wafer, and so on. A silicon dioxide (insulator) layer 512 can be grown, deposited, or otherwise formed on the silicon wafer. One or more waveguides, such as waveguide 520, can be formed on the insulator layer 512. Any number of waveguides can be formed on the insulator layer 512. Another silicon dioxide insulator layer 530 can be placed over the one or more waveguides. The insulator layer 530 can be planarized in order to enable fabrication of further elements. The waveguide can conduct light in order to establish optical communications between an optical source and an optical receiver within the PWSI. The waveguide can be utilized by a first chiplet such as a switching chiplet. The first chiplet can send data to a first surface-emitting light source such as a vertical-cavity surface-emitting laser (VCSEL). The VCSEL can convert the data from the first chiplet into optical data. The optical data can be coupled to a waveguide using an optical coupler such as a mirror fabricated using a nanoimprint lithography technique. A second optical coupler can couple light sent through the waveguide and can transfer the optical data to a second chiplet.

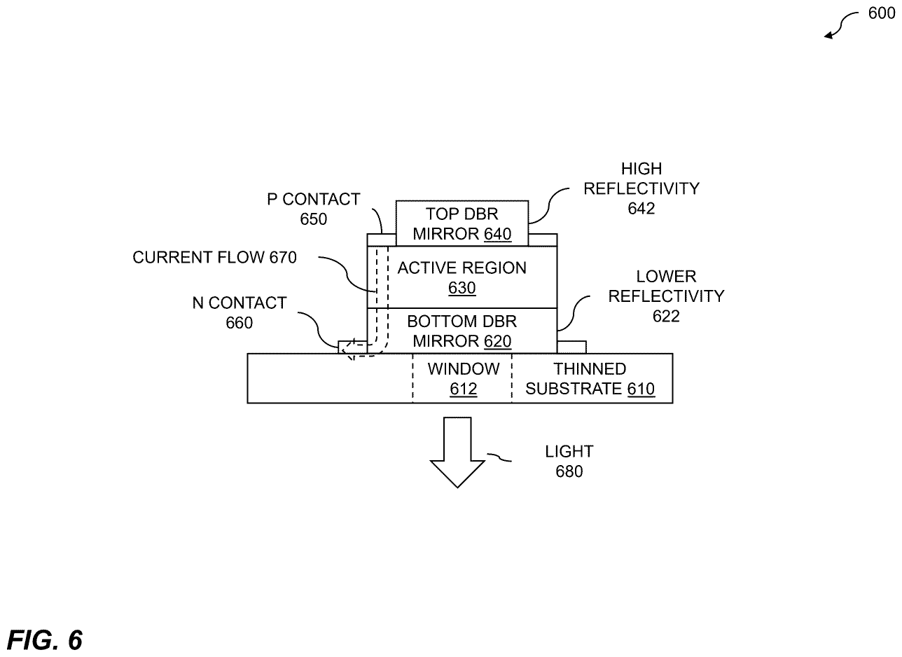

FIG. 6 is a cross section of a VCSEL. One or more optical modulators such as surface-emitting light sources can be deposited on a front side of a photonic wafer-scale interposer (PWSI). The interposer can be based on a wafer, such as a silicon wafer. The one or more surface-emitting light source can be based on a variety of light emitting techniques. In embodiments, the plurality of surface-emitting light sources comprises a plurality of vertical-cavity surface-emitting lasers (VCSELs). A VCSEL can generate and emit light at one or more wavelengths, with one or more polarizations, with one or more modes, with an intensity, etc. One or more characteristics such as the above can enable conveyance of the light from the VCSEL into the PWSI. The characteristics can further enable coupling the light to a waveguide, and transmission of the light through the waveguide. The wavelength can further enable coupling the light from the waveguide to a receiver. The VCSEL can be used to transmit data. Transmitting data is enabled using a hierarchical redundancy with parallel optical links.

The block diagram 600 includes a thinned substrate 610. The thinned substrate can include a variety of materials suitable to fabricating a VCSEL. In a usage example, the substrate can include a gallium-arsenide (GaAs) substrate. Other substrates that can be used can include aluminum-gallium-arsenide (AlGaAs), germanium (Ge), sapphire (Al₂O₃), and so on. The substrate can be thinned to enable fabrication of a window 612. Light is emitted by the VCSEL. The light emitted by the VCSEL can exit the VCSEL by passing through the window in the thinned substrate.

The VCSEL structure consists of an active region that is placed between two highly reflective mirrors. The first mirror includes a first reflectivity, and the second mirror includes a second reflectivity. In a usage example, the two highly reflective mirrors can be based on Distributed Bragg Reflectors (BDRs). These can be formed from multiple, alternating layers of materials, where the materials have different refractive indices. In the block diagram 600, a Distributed Bragg Deflector mirror can include a bottom mirror 620. The bottom mirror can include an n-Distributed Bragg Reflector. The bottom mirror can include a reflectivity that is lower than a top mirror (described below). In a usage example, the reflectivity 622 of the bottom DBR can include a reflectivity of 93 percent to 99 percent. Another reflectivity can be used. The n-Distributed Bragg Reflectors associated with the bottom mirror can be insulated from other layers in the block diagram by an oxide layer (not shown).

The block diagram 600 includes an active region 630. The active region can comprise a region in which light can be generated. The light can be generated using a variety of techniques. In a usage example, the active region can include a structure such as a quantum well structure. The active region can be located within a laser cavity. The block diagram 600 can include an additional oxide layer (not shown) between the active region and a top DBR mirror. The oxide layer between the bottom mirror and the active area, and oxide layer between the active layer and the top mirror may or may not be present in the VCSEL. When present, the oxide layers can confine the light and electrical current within the active area. The block diagram 600 includes p-Distributed Bragg Reflector mirror 640. In the block diagram 600, the p-Distributed Bragg Reflector mirror comprises the top mirror of the VCSEL. The top mirror can include a reflectivity 642. In a usage example, the reflectivity of the top DBR can include a reflectivity of 99.4 percent to 99.9 percent. Another reflectivity can be used.

An electrical current is applied to the VCSEL in order for the VCSEL to lase and to emit light. The electrical current can be applied to the top p-Distributed Bragg Reflector mirror using a p contact 650. The electrical current can exit the bottom n-Distributed Bragg Reflector mirror using an n contact 660. The electrical current can flow 670 from the p contact to the n contact. The VCSEL emits light 680. The light from the VCSEL can be emitted at an angle that can be substantially normal to a substrate to which the VCSEL can be coupled. When the light emitted by the VCSEL needs to be angled, then an optical device can be used. A usage example can include angling the light that was emitted by the first surface-emitting light source, wherein the angling is based on a micro-optical element (MOE). The MOE can be based on a lens, a grating, a bent waveguide, and so on.

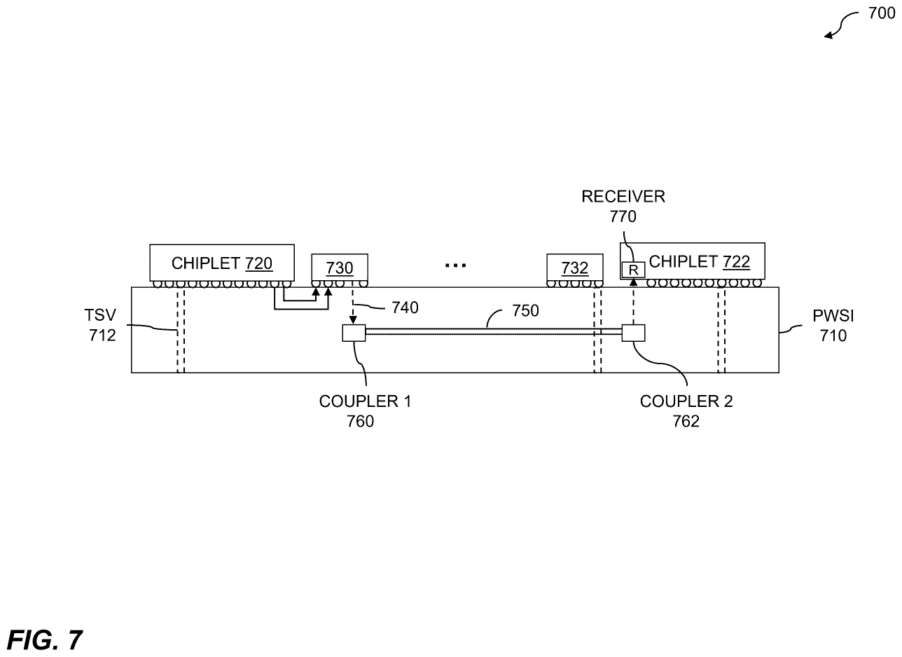

FIG. 7 is a cross-section of a photonic wafer-scale interposer (PWSI). The PWSI includes a plurality of optical links. The plurality of optical links includes at least one spare optical link. The optical links can be bundled and grouped to form a hierarchy. Each optical link in the plurality of optical links includes an optical modulator, an optical coupler, and an optical medium. In order to improve interconnection bandwidth and/or speed, chiplets, such as switching chiplets, AI chiplets, surface-emitting light sources, and so on can be bonded to a front side of a photonic-scale integration interposer (PWSI). The PWSI shown in illustration 700 includes an optical link. The optical link includes an optical modulator such as a vertical cavity surface emitting laser (VCSEL); an optical coupler such as a mirror, bent waveguide or grating coupler; and an optical medium such as a waveguide. A waveguide within the PWSI can enable coupling between any number of chiplets bonded to the PWSI. The waveguides can be used to transfer data as optical signals between chiplets.

Coupling between the chiplets and the waveguides is accomplished by one or more optical modulators and optical couplers. The optical modulators include light sources such as surface-emitting light sources. The light sources can include a VCSEL, a laser diode (LD), a light emitting diode (LED), etc. Data such as serial electronic data from a chiplet can be sent to an optical modulator. The optical modulator can translate the electronic data into light (e.g., optical data) and emit the light vertically, substantially vertically, etc. into the PWSI. A first optical coupler can couple the light from the optical modulator to a waveguide which can convey the light any distance across the PWSI. To accommodate longer paths, the waveguides can be manufactured via nanoimprint lithography, or another suitable fabrication technology. In a usage example, the fabricating does not include reticle stitching. The “far” end of the waveguide can comprise a second optical coupler. The second optical coupler can couple the light from the waveguide to an optical receiver which can convert the optical data to electrical data. The optical receiver can be a device that is separate from the second chiplet, can be within the second chiplet, and so on. Thus, high bandwidth, high speed photonic communication for transmitting data can be enabled across the PWSI using hierarchical redundancy with parallel optical links.

A front side of the PWSI is bonded to a plurality of chiplets. The chiplets can be connected, attached, bonded, or otherwise coupled to the PWSI 710. In illustration 700, chiplet 720 and chiplet 722 are bonded to the front side of the PWSI. The chiplets can include AI accelerators, switching chiplets, ASICS, I/O chips, and so on. The chiplets can be bonded to the PWSI with micro-bumps, controlled collapse chip connections (C4s), and so on. The bonding can be accomplished via laser-assisted bonding or another bonding method, such as a flip-chip application. The PWSI can include a plurality of through-silicon vias (TSVs) such as TSV 712. A TSV can include an electrical connection that passes completely through a wafer such as a silicon wafer, a glass wafer, or a die. The plurality of TSVs can be oriented vertically in order to enable connections between the front side of the wafer and the back side of the wafer. A chiplet can be coupled to an optical modulator. The optical modulator can include a light source such as a surface-emitting light source. In embodiments, each optical modulator within the plurality of optical links comprises a vertical cavity surface emitting laser (VCSEL), wherein each VCSEL is bonded to the front side of the PWSI, and wherein each VCSEL is within the plurality of chiplets. The surface-emitting light source can also include a light emitting diode (LED), a laser diode (LD), etc. Other light sources can also be used. The PWSI can include one or more surface-emitting light sources such as optical modulator 730 and optical modulator 732.

Data is sent by a first chiplet to a second chiplet. In embodiments, the source comprises a first chiplet, wherein the destination comprises a second chiplet, wherein the first chiplet and the second chiplet are within a plurality of chiplets bonded to a front side of a phonic wafer-scale interposer (PWSI). The sending is based on a first optical medium such as a waveguide. A first waveguide, waveguide 750 within the plurality of waveguides on the PWSI, is shown. The waveguide can include one or more confinement regions, such as a high confinement region, a low confinement region, and so on. The waveguide can include a transition between confinement regions associated with the waveguide. The transition can include an adiabatic tapering of the waveguide. The second chiplet, such as chiplet 722 can receive the data that was sent. Data from the sending (e.g., first) chiplet can be converted from electrical data, which can be serialized electrical data, to optical data. The optical data can be sent via the waveguide and reconverted to electrical data to be received by the receiving (e.g., second) chiplet. In a usage example, the sending includes transmitting the data, by the first chiplet, to a first surface-emitting light source within one or more surface-emitting light sources. The electrical data can be converted to optical data using the surface-emitting light source, such as optical modulator 730.

In order to couple light from a surface-emitting light source to a waveguide, the light is conveyed to an optical coupler. Optical information is conveyed 740, from the first optical modulator 730, to a first optical coupler 760. The first optical coupler couples the optical information, which is based on the data sent from the first chiplet, to the first waveguide 750. The first coupler can be based on one or more coupling techniques. In embodiments, each optical coupler within the plurality optical links comprises a mirror. The mirror can include a nanoimprint lithography (NIL) process mirror. In embodiments, each optical coupler within the plurality optical links comprises a bent waveguide. The bent waveguide can include a high confinement region of a waveguide. In further embodiments, wherein each optical coupler within the plurality optical links comprises a grating coupler. The optical coupler can be tuned to enable a substantially maximum coupling of light from the optical modulator into the waveguide. In a usage example, the light that was emitted by the first optical modulator can be angled, where the angling is based on a micro-optical element (MOE). The MOE can be coupled to the first optical modulator in order to angle the emitting light. In a usage example, the MOE can be placed over or near the laser opening of a VCSEL. In a usage example, the MOE can include a micro lens, a diffractive optical element, a Fresnel lens, an asymmetric non-focusing optical device, and so on.

The second chiplet 722 can receive the data that was sent. The receiving can include coupling the optical information, using a second optical coupler 762, from the first waveguide to an optical receiver. The second optical coupler can be based on one or more receiving techniques. The second optical coupler can comprise a grating coupler. The grating coupler can diffract light at specific frequencies, input angles, etc. to enable efficient transfer of light out of a waveguide within the PWSI. The second optical coupler can comprise a photodiode. The photodiode can convert the optical data to digital data. The data received at the optical coupler can be transferred. The data can be transferred by the optical receiver to the second chiplet. The data can be transferred as optical data or transferred as digital data. The data can be received at the second chiplet by a receiver 770. If the receiver receives optical data, the receiver can convert the optical data to digital data. If the receiver receives digital data, the digital data can be used as received, converted from serial data to parallel data, and so on.

Embodiments further include coupling, to the back side of the PWSI, a plurality of modular power substrates (MPSs) (not shown). The MPSs can be further coupled to a plurality of DC-to-DC converters (not shown). The plurality of DC-to-DC converters can comprise a unified control board (UCB). The coupling of the MPSs to the PWSI can be achieved by a number of techniques. The MPSs can be bonded to a back side of the PWSI by laser-assisted bonding (LAB). The LAB can create localized heat at points, by one or more lasers, on the PWSI where the MPSs are bonded to the PWSI. The bonding can be accomplished using solder balls such as microbumps, controlled collapse chip connections (C4s), ball grid arrays (BGAs), and so on. The bonding of the MPSs to the PWSI can include bonding the MPSs to one or more through-silicon vias (TSVs) such as TSV 712. The laser-assisted bonding is able to create heat at the solder balls without heating the PWSI using a reflow soldering technique. Heating the PWSI using a reflow technique can cause previously soldered connections to reflow and potentially disconnect or short, damage diffusions, damage waveguides, and so on.

Alternatively, the MPSs can be coupled to a back side of the PWSI via one or more elastomer sheets (not shown). The one or more elastomer sheets can comprise a conductive filament, such as brass, gold, etc., embedded in a silicone rubber sheet, or another suitable material. The filaments can be embedded on a pitch. The pitch can be designed to match a connector array, such as a ball grid array (BGA) of the MPS. The elastomer sheet can be held in place with a compression force which can be delivered by one or more compression plates (not shown). An adhesive backing can be added to the elastomer sheet. When one or more filaments come in contact with a C4, contact can be made between the C4 of the MPS and a solder bump, microbump, or C4 associated with the PWSI. One or more filaments can make contact with one or more TSVs. Once coupled to the back side of the PWSI, The MPSs can send power to the chiplets.

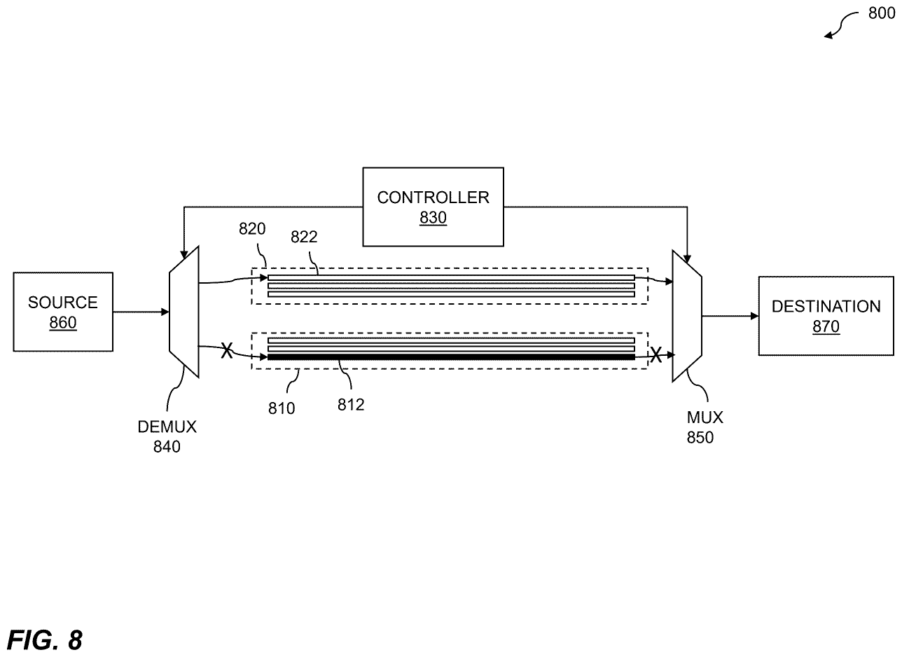

FIG. 8 is an apparatus for hierarchical redundancy with parallel optical links. The apparatus is used for transmitting data. The transmitting data can be accomplished using groups of bundles of optical links. A bundle includes a plurality of optical links, where at least one link within the plurality of optical links is a spare optical link. Each optical link in the plurality of optical links includes an optical modulator, an optical coupler, and an optical medium. The optical links enable transmitting data from a source to a destination. In embodiments, the source comprises a first chiplet, wherein the destination comprises a second chiplet, wherein the first chiplet and the second chiplet are within a plurality of chiplets bonded to a front side of a phonic wafer-scale interposer (PWSI). The transmitting data can be further accomplished using back side power delivery. Various electronic and optical elements can be attached, bonded, mounted, or otherwise coupled to the photonic wafer-scale interposer (PWSI). The electronic elements can include chiplets such as AI accelerators based on AI chiplets, network switches based on switching chiplets, memories, and so on. The optical elements can include optical modulators such as VCSELs, LEDs, laser diodes, photodiodes, and the like. The optical elements further include optical couplers such as mirrors, grating couplers, and bent waveguides; and optical mediums such as waveguides. Power such as DC power can be sent by a controller to a plurality of chiplets and other electronic and optical elements. The controller can comprise a universal control board (UCB). The sending can be accomplished using a plurality of DC-to-DC converters, a plurality of modular power substrates (MPSs), and a plurality of through-silicon vias (TSVs). The plurality of optical elements, chiplets, etc. can be bonded to a front side of a photonic wafer-scale interposer (PWSI). The plurality of MPSs can be coupled to a backside of the PWSI, where the coupling is based on an elastomer sheets, laser-assisted bonding (LAB), and so on. The MPSs can be mechanically coupled to the UCB based on a plurality of high-power sockets. The UCB can further include a plurality of DC-to-DC power converters.

An apparatus for transmitting data is disclosed comprising: a plurality of optical links, wherein each optical link in the plurality of optical links includes an optical modulator, an optical coupler, and an optical medium, wherein the plurality of optical links includes at least one spare optical link, and wherein the plurality of optical links comprises a bundle of optical links; a group of at least two bundles of optical links; a failing optical link within one or more optical links, within the group, that were tested; a controller, wherein the controller replaces the failing optical link with a spare optical link within any bundle within the group; and a source, wherein the source transmits data to a destination, wherein transmitting is based on the spare optical link.

The apparatus 800 comprises a plurality of optical links, wherein each optical link in the plurality of optical links includes an optical modulator, an optical coupler, and an optical medium, wherein the plurality of optical links includes at least one spare optical link, and wherein the plurality of optical links comprises a bundle of optical links. Discussed previously, an optical modulator can include a light source such as a surface-emitting light source. In embodiments, each optical modulator within the plurality of optical links comprises a vertical cavity surface emitting laser (VCSEL), wherein each VCSEL is bonded to the front side of the PWSI, and wherein each VCSEL is within the plurality of chiplets. The optical modulator can also include a laser diode (LD), a light emitting diode (LED), and so on. The optical coupler couples light from the optical modulator to the optical medium. In embodiments, each optical coupler within the plurality optical links comprises a mirror. The optical mirror can include a nanoimprint lithography (NIL) mirror. In other embodiments, each optical coupler within the plurality optical links comprises a bent waveguide. Each bent waveguide can include a high-containment bent waveguide. In further embodiments, each optical coupler within the plurality optical links comprises a grating coupler. The grating coupler can be tuned to a wavelength or band of wavelengths emitted by the optical modulator. In a usage example, a coupler can include a photodiode. The optical medium can include a waveguide. In embodiments, each optical medium within the plurality of optical links comprises a waveguide within the PWSI.

The apparatus 800 comprises a group of at least two bundles of optical links. Two bundles of optical links are shown, bundle 810 and bundle 820. The bundles 810 and 820 each include at least one spare link. A bundle of optical links can comprise all spare links. Bundles of optical links can be grouped together to form groups. More than one group can be formed from bundles of optical links. In embodiments, the apparatus comprises a second group of at least two bundles of optical links. The apparatus 800 is shown with a first group comprising two bundles of optical links, bundle 810, and bundle 820. The second group (not shown) can be used independently of the first group, can include optical links that can serve as replacement optical links for failed links in the first group, and so on. Thus, in this example, the second group can include a redundant group of optical links. In embodiments, the replacing comprises a redundancy implementation.

Any element of the optical link, such as the optical modulators and optical couplers, which can include photodiodes, can operate with degraded performance or can fail.

The optical modulators in particular can be prone to degradation and failure. To ensure that a given optical link is operating properly, the optical link can be tested. The testing can be performed during manufacturing of optical elements, at runtime, at system startup, and so on. In embodiments, the testing comprises runtime testing. The runtime testing can be performed on optical links between data transmissions. In other embodiments, the testing comprises manufacturing testing. Manufacturing testing can be performed at various stages of the manufacturing processes associated with the optical elements comprising the optical links. The manufacturing testing can confirm contact and interconnect integrity, device operation, and the like. In further embodiments, the testing is based on built-in self-test (BIST). The BIST can be performed upon system startup, when a device is idle, etc. The runtime testing and the BIST can be performed by a controller (discussed below).

The apparatus 800 comprises a failing optical link within one or more optical links, within the group, that were tested. A failing link can be identified by the testing. In the figure, optical link 812 has been identified as failing so that it can be replaced. The spare optical link 822 can be used to replace the failed link 812. The apparatus 800 includes a controller 830, wherein the controller replaces the failing optical link with a spare optical link within any bundle within the group. The controller can replace failed link 812 with spare link 822. The replacement of the failed link is shown to take place within a given group of bundles of optical links. In embodiments, the controller comprises a shift register. The shift register can shift a selection bit, a code, and so on, in order to route a source to the spare optical link. The spare optical link can be within any bundle, any group, etc. In embodiments, the spare optical link is within the second group (not shown in apparatus 800). The controller can deselect a failed optical link and replace the failed link by selecting a spare link. The deselecting and selecting can be accomplished using a demultiplexer (DE) such as demux 840. The controller can further deselect the failed optical link and select the spare optical link at the far end of the optical medium using a multiplexer (MUX) such as mux 850.

The apparatus 800 comprises a source 860, wherein the source transmits data to a destination 870, wherein transmitting is based on the spare optical link. In the FIG. 800, the source transmits data which is directed by the demux 840 to the spare optical link 822 within bundle 820. The directing by the demux from the source into the spare optical link is managed by the controller. Similarly, the data that is transmitted via the spare optical link is directed by a mux to the destination. The mux is also managed by the controller. In embodiments, the source comprises a first chiplet, wherein the destination comprises a second chiplet, wherein the first chiplet and the second chiplet are within a plurality of chiplets bonded to a front side of a phonic wafer-scale interposer (PWSI). The chiplets can include processor chiplets, AI accelerator chiplets, memory chiplets, and so on. In embodiments, the source and the destination comprise silicon photonics chips.

The apparatus can provide power to the chiplets bonded to the PWSI. Embodiments include providing power to the plurality of chiplets, wherein the providing is based on a back side of the PWSI, and wherein the PWSI includes a plurality of through-silicon vias (TSVs). The power can be provided to the chiplets modular power substrates. Embodiments further comprise coupling, to the back side of the PWSI, a plurality of modular power substrates (MPSs). Each MPS within the plurality of MPSs can include a connector or a socket for coupling the MPS to other components associated with the apparatus. The socket can include a socket on a unified control board (UCB) (described below). The socket can comprise a high-power socket, a high voltage socket, and so on. The connector or socket can include one or more plugs, pins, terminals, contacts, etc. from the UCB which can be inserted into a socket. In a usage example, the coupling can be based on a high voltage socket. Embodiments further comprise coupling the plurality of MPSs to a unified control board (UCB), wherein the coupling is based on a plurality of sockets, and wherein the UCB includes a plurality of DC-to-DC power converters. UCB can include one or more controllers that can be used to control the plurality of DC-to-DC converters, the MPSs, and so on. The controller can select and deselect DC-to-DC converters, select DC voltages, select and deselect MPSs, etc. The high voltage socket can transfer power from the UCB to the plurality of MPSs.

The high voltage socket can be used to provide a first DC voltage. The first DC voltage can be provided by a DC-to-DC converter. The first DC voltage can be converted to a second DC voltage by one or more DC-to-DC converters. Embodiments include delivering DC power, by the UCB, to the plurality of chiplets, wherein the delivering is based on the plurality of DC-to-DC power converters, the plurality of MPSs, and the plurality of TSVs, and wherein the delivering includes a first voltage conversion. The DC power that is provided can include a range for the DC voltage. The range of DC voltage can include a percentage of a target voltage, an allowable operating range of DC voltage, and the like. In a usage example, the voltage range can include 48 volts to 54 volts, inclusive. The delivering can include a first voltage conversion.

Embodiments further include transferring the DC power from the UCB, by the plurality of MPSs, to the plurality of chiplets, wherein the transferring includes a second voltage conversion. The plurality of chiplets can obtain the transferred power using interconnect, contacts, and so on. The chiplets and other electronic elements can also use interconnect and contacts to receive and send data, instructions, control signals, etc. The second voltage conversion can be accomplished using one or more converters such as DC-to-DC converters associated with the MPSs. The second voltage conversion can produce a voltage that can be used directly to operate one or more chiplets. The second voltage conversion can attain a voltage less than the voltage resulting from the first voltage conversion. The second voltage conversion can result in a voltage less than a threshold. The threshold can include a target voltage, an operating voltage, and so on. In a usage example, the threshold is 1 volt. The transferring is based on the plurality of TSVs. The transferring can include transferring DC power, receiving and sending data, sending and receiving functional chip instructions and control signals, etc.

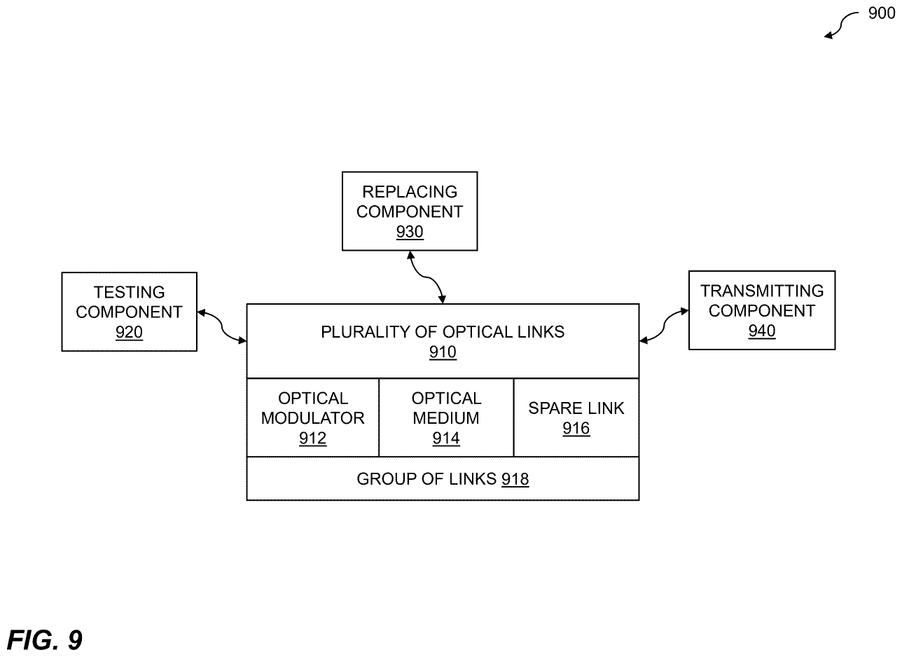

FIG. 9 is a system diagram for hierarchical redundancy with parallel optical links. A plurality of optical links enables high-speed communications between a plurality of sources and plurality of destinations. Highspeed communication includes transmitting data between a source and a destination. In embodiments, the source and the destination comprise silicon photonics chips. The silicon photonics chips can include chiplets within a plurality of chiplets bonded to a photonic wafer-scale interposer. The source and the destination can be located remotely from each other. The sent data can include electronic data such as serial electronic data. The electronic data is converted to optical data and sent via an optical link. The electronic data is converted using an optical modulator, conveyed to an optical coupler, and transmitted using an optical medium. An optical link comprises the optical modulator, the optical coupler, and the optical medium. Data can be transmitted between sources and destination, where the sources and the destinations can include silicon photonic chips. The optical modulator can include a first surface-emitting light source. The surface-emitting light source can include a VCSE. The surface-emitting light source converts the electronic data to optical data. The sending includes emitting light by the surface-emitting light source toward a first optical coupler. The first optical coupler can include a mirror, a lens, a grating, a curved or bent waveguide, and so on. The emitted light is coupled by the optical coupler to an optical medium. The optical medium can include a waveguide such as a waveguide fabricated by a nanoimprint lithography (NIL) process. The light that is transmitted from the source via the optical link is received by the destination. The receiving can be accomplished using an optical coupler such as a photodiode.

A plurality of optical links is bundled. Each optical link in the plurality of optical links includes an optical modulator, an optical coupler, and an optical medium. The plurality of optical links includes at least one spare optical link. The optical modulator can include a vertical-cavity surface-emitting laser (VCSEL), a light emitting diode (LED), a laser diode (LD), etc. The optical coupler can include a mirror, a bent waveguide, a grating coupler, and the like. The optical medium can include a waveguide, a multicore fiber, etc. The bundling results in a bundle of optical links. At least two bundles of optical links are grouped. The grouping results in a group of optical links. One or more optical links within the group are tested. The testing can be accomplished by a processor, a testing processor, a controller, and so on. The testing includes identifying a failing optical link within the one or more of optical links that were tested. A controller replaces the failing optical link with a spare optical link. The spare optical link is within any bundle within the group. Data is transmitted from a source to the spare optical link. The transmitting includes forwarding the data from the spare optical link to a destination.

Disclosed is a system for transmitting data comprising: a plurality of optical links, wherein each optical link in the plurality of optical links includes an optical modulator, an optical coupler, and an optical medium, wherein the plurality of optical links includes at least one spare optical link, and wherein the plurality of optical links comprises a bundle of optical links; and a group of at least two bundles of optical links, wherein the system is configured to: test one or more optical links, within the group, wherein the testing includes identifying a failing optical link within the one or more optical links that were tested; replace the failing optical link, by a controller, with a spare optical link, wherein the spare optical link is within any bundle within the group; and transmit data from a source to the spare optical link, wherein transmitting includes forwarding the data from the spare optical link to a destination.

The system 900 comprises a plurality of optical links 910, wherein each optical link in the plurality of optical links includes an optical modulator 912, an optical coupler, and an optical medium 914, wherein the plurality of optical links includes at least one spare optical link 916, and wherein the plurality of optical links comprises a bundle of optical links. The optical links enable high-speed transmitting of data between a source and a destination. The source and the destination can include functional chips, chiplets, processors, memories, and so on. In embodiments, the source comprises a first chiplet, wherein the destination comprises a second chiplet, wherein the first chiplet and the second chiplet are within a plurality of chiplets bonded to a front side of a phonic wafer-scale interposer (PWSI). The optical modulator can convert electronic data to optical data by emitting light that is based on the electronic data. In embodiments, each optical modulator within the plurality of optical links comprises a surface-emitting light source. The surface-emitting light source can emit a wavelength of light, a band of wavelengths of light, and so on. In embodiments, each optical modulator within the plurality of optical links comprises a vertical cavity surface emitting laser (VCSEL), wherein each VCSEL is bonded to the front side of the PWSI, and wherein each VCSEL is within the plurality of chiplets. The surface-emitting light source can include a laser diode (LD), a light emitting diode (LED), and the like.

The optical coupler can be based on a variety of optical coupler techniques. In embodiments, each optical coupler within the plurality optical links comprises a mirror. The mirror can be fabricated using a nanoimprint lithography (NIL) processes. In other embodiments, each optical coupler within the plurality optical links comprises a bent waveguide. The bent waveguide can include a high-containment waveguide which can minimize loss of light from the waveguide. In further embodiments, each optical coupler within the plurality optical links comprises a grating coupler. The grating coupler, which can include a periodic coupler, can be tuned to maximize transfer of the wavelength of light or a band of wavelengths of light. In the system 900, each optical link includes an optical medium 914. The optical medium can enable transmission of light that is coupled from the surface-emitting light source, by the optical coupler, into the optical medium. In embodiments, each optical medium within the plurality of optical links comprises a waveguide within the PWSI. The waveguide can enable high-speed communication between a source chiplet and a destination chiplet on the PWSI. In other embodiments, the optical medium within the plurality of optical links comprises a multicore fiber. The system 900 includes a spare optical link 916. The spare optical link can be bundled with other optical links. A bundle of optical links includes at least on spare optical link. A bundle can comprise entirely spare optical links. The system 900 comprises a group 918 of at least two bundles of optical links. Recall that each bundle of optical links includes a plurality of optical links, where at least one optical link with the plurality of optical links is a spare link. The bundles that are grouped together in a group can include substantially similar numbers of optical links and spare links within in bundle or can include substantially different numbers of optical links and spare links.

The system 900 includes a testing component 920. The testing component 920 is configured to test one or more optical links, within the group, wherein the testing includes identifying a failing optical link within the one or more optical links that were tested. A component of the optical link can fail or degrade due to one or more of fabrication errors, degradation over time, and so on. By identifying a failed or failing optical link, the problematic optical link can be switched out and replaced by a spare optical link. Various types of testing techniques can be used. In embodiments, the testing comprises runtime testing. The runtime testing can be performed on optical links between data transmissions, such as testing a link when the link is not in use. In other embodiments, the testing comprises manufacturing testing. Manufacturing testing is performed at various stages of the manufacturing processes associated with the optical elements comprising the optical links. The manufacturing testing can confirm contact and interconnect integrity, device operation, and the like. Underperforming or failed components can be identified and discarded long before the components are introduced to a system, the PWSI, etc. In further embodiments, the testing is based on built-in self-test (BIST). The BIST can be performed upon system startup, when a device is idle, etc. The runtime testing and the BIST can be performed by a controller.

The system 900 includes a replacing component 930. The replacing component 930 is configured to replace the failing optical link, by a controller, with a spare optical link, wherein the spare optical link is within any bundle within the group. The replacing can be accomplished by “swapping out” or deselecting the failed optical link based on the testing results. In embodiments, the replacing comprises a redundancy implementation. The replacing can include replacing the failed optical link with a spare link within the same bundle as the failed optical link. The replacing can include replacing the failed optical link with a spare bundle within the same group, within a different group, and so on. In embodiments, the spare optical link is within the second group. Recall that the second group includes at least one spare optical link. In embodiments, the second group comprises a spare bundle of optical links. Thus, the second group can implement redundancy. In embodiments, the grouping, the testing, and the replacing include a second group. The choice of using a spare link in the second group can be based on testing the optical links within the second group.

The system 900 includes a transmitting component 940. The transmitting component 940 is configured to transmit data from a source to the spare optical link, wherein transmitting includes forwarding the data from the spare optical link to a destination. The transmitting data from the source to the destination can be controlled by the controller. The source sends data such as serial electronic data to an optical modulator selected by the controller. The optical modulator converts the electronic data to optical data such as serial optical data. The optical coupler associate with the optical link couples the light (e.g., serial optical data) from the optical modulator to the optical medium. The optical medium, such as a waveguide within the PWSI, conveys the optical data to an optical receiver. In embodiments, each optical link within the plurality of optical links includes a photodiode. The photodiode converts the optical data to electronic data. The electronic data can be routed to the receiver.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for transmitting data comprising:
bundling a plurality of optical links, wherein each optical link in the plurality of optical links includes an optical modulator, an optical coupler, and an optical medium, wherein the plurality of optical links includes at least one spare optical link, and wherein the bundling results in a bundle of optical links;
grouping at least two bundles of optical links, wherein the grouping results in a group of optical links;
testing one or more optical links, within the group, wherein the testing includes identifying a failing optical link within the one or more of optical links that were tested;
replacing the failing optical link, by a controller, with a spare optical link, wherein the spare optical link is within any bundle within the group; and
transmitting data from a source to the spare optical link, wherein the transmitting includes forwarding the data from the spare optical link to a destination.

2. The method of claim 1 wherein the source comprises a first chiplet, wherein the destination comprises a second chiplet, wherein the first chiplet and the second chiplet are within a plurality of chiplets bonded to a front side of a phonic wafer-scale interposer (PWSI).

3. The method of claim 2 wherein each optical modulator within the plurality of optical links comprises a vertical cavity surface emitting laser (VCSEL), wherein each VCSEL is bonded to the front side of the PWSI, and wherein each VCSEL is within the plurality of chiplets.

4. The method of claim 3 wherein each optical medium within the plurality of optical links comprises a waveguide within the PWSI.

5. The method of claim 4 wherein each optical coupler within the plurality optical links comprises a mirror.

6. The method of claim 4 wherein each optical coupler within the plurality optical links comprises a bent waveguide.

7. The method of claim 4 wherein each optical coupler within the plurality optical links comprises a grating coupler.

8. The method of claim 3 further comprising providing power to the plurality of chiplets, wherein the providing is based on a back side of the PWSI, and wherein the PWSI includes a plurality of through-silicon vias (TSVs).

9. The method of claim 8 further comprising coupling, to the back side of the PWSI, a plurality of modular power substrates (MPSs).

10. The method of claim 9 further comprising coupling the plurality of MPSs to a unified control board (UCB), wherein the coupling is based on a plurality of sockets, and wherein the UCB includes a plurality of DC-to-DC power converters.

11. The method of claim 10 further comprising delivering DC power, by the UCB, to the plurality of chiplets, wherein the delivering is based on the plurality of DC-to-DC power converters, the plurality of MPSs, and the plurality of TSVs, and wherein the delivering includes a first voltage conversion.

12. The method of claim 11 further comprising transferring the DC power from the UCB, by the plurality of MPSs, to the plurality of chiplets, wherein the transferring includes a second voltage conversion.

13. The method of claim 1 wherein the controller comprises a shift register.

14. The method of claim 1 wherein the replacing comprises a redundancy implementation.

15. The method of claim 1 wherein the testing comprises runtime testing.

16. The method of claim 1 wherein the testing comprises manufacturing testing.

17. The method of claim 16 wherein the testing is based on built-in self-test (BIST).

18. The method of claim 1 wherein the source and the destination comprise silicon photonics chips.

19. The method of claim 18 wherein the optical medium within the plurality of optical links comprises a multicore fiber.

20. The method of claim 1 wherein each optical link within the plurality of optical links includes a photodiode.

21. The method of claim 1 wherein each optical modulator within the plurality of optical links comprises a surface-emitting light source.

22. The method of claim 1 wherein the grouping, the testing, and the replacing include a second group.

23. The method of claim 22 wherein the spare optical link is within the second group.

24. The method of claim 22 wherein the second group comprises a spare bundle of optical links.

25. An apparatus for transmitting data comprising:
a plurality of optical links, wherein each optical link in the plurality of optical links includes an optical modulator, an optical coupler, and an optical medium, wherein the plurality of optical links includes at least one spare optical link, and wherein the plurality of optical links comprises a bundle of optical links;
a group of at least two bundles of optical links;
a failing optical link within one or more optical links, within the group, that were tested;
a controller, wherein the controller replaces the failing optical link with a spare optical link within any bundle within the group; and
a source, wherein the source transmits data to a destination, wherein transmitting is based on the spare optical link.

26. The apparatus of claim 25 further comprising a second group of at least two bundles of optical links.

27. The apparatus of claim 26 wherein the spare optical link is within the second group.

28. A system for transmitting data comprising:
a plurality of optical links, wherein each optical link in the plurality of optical links includes an optical modulator, an optical coupler, and an optical medium, wherein the plurality of optical links includes at least one spare optical link, and wherein the plurality of optical links comprises a bundle of optical links; and
a group of at least two bundles of optical links, wherein the system is configured to:
test one or more optical links, within the group, wherein the testing includes identifying a failing optical link within the one or more optical links that were tested;
replace the failing optical link, by a controller, with a spare optical link, wherein the spare optical link is within any bundle within the group; and
transmit data from a source to the spare optical link, wherein transmitting includes forwarding the data from the spare optical link to a destination.
